(19) United States
(12) Patent Application Publication
(10) Pub. No.: US 2021/0025417 A1
(43) Pub. Date: Jan. 28, 2021

(54) SHEET METAL ASSEMBLY WITH CONDITIONED WELD JOINT

(71) Applicant: Shiloh Industries, Inc., Valley City, OH (US)

(72) Inventors: James W. Walther, Chatham, OH (US); Kevin D. Hamann, Medina, OH (US); Erick B. Tomlinson, Parma, OH (US); Steve Skrzypek, Brunswick, OH (US)

(21) Appl. No.: 16/935,966

(22) Filed: Jul. 22, 2020

Related U.S. Application Data
(60) Provisional application No. 62/878,138, filed on Jul. 24, 2019.

(51) Int. Cl. F16B 5/08; B23K 26/26

(52) U.S. Cl. CPC F16B 5/08; B23K 26/26

(57) ABSTRACT

A sheet metal assembly includes sheet metal pieces joined by a weld joint. An initial weld joint is subsequently conditioned in a manner that reduces the size of a recess in the initial weld joint and/or changes its grain structure. A laser beam or other heat source can be used to condition the weld joint. The resulting change in weld joint geometry and/or grain structure improves the formability of the sheet metal assembly at the weld joint and is particularly advantageous when butt welding same-gauge sheet metal and/or aluminum alloys.

### FIELD

The present disclosure relates to welding and, more particularly, to processes for welding sheet metal pieces together and to the resulting sheet metal assembly.

### BACKGROUND

Since the earliest days of metal welding, the effects of gravity have presented numerous problems due to the tendency of molten metal to flow somewhat uncontrollably during welding processes. In some cases, the orientation of the parts to be welded together can be used to control the flow of the molten metal. For instance, a lap weld can be made along the edge of the top piece so that the molten material forms a fillet. A similar technique can be used to butt weld a thick piece of material to a thin piece of material by forming the weld from the top side and along the edge of the thick piece so that the molten material forms a fillet atop the thin piece. When butt welding two materials having the same thickness, however, the molten material tends to flow along the interface where the materials are abutted. This is especially true with metals having a low melting point and/or a low viscosity in the liquid state. The result is unwanted material displacement away from the area being welded. The conventional solution has been to use a filler material, usually in the form of a metal wire, which is melted along with the materials to be joined to add to the weld joint in replacement of the material that flows away. This presents its own set of problems, including difficulties with automating the process.

### SUMMARY

In accordance with various embodiments, a method includes the steps of forming a weld joint along abutting edges of two sheet metal pieces and subsequently heating the weld joint such that a recess of the weld joint is decreased in size without additional material being added.

In some embodiments, the step of heating the weld joint includes directing a defocused laser beam along the recess.

In some embodiments, the step of forming the weld joint includes directing a focused laser beam along the abutting edges of the sheet metal pieces without additional material being added. A laser spot of the defocused laser beam is larger than a laser spot of the focused laser beam.

In some embodiments, the step of heating the weld joint includes changing an orientation of grains of a grain structure of the weld joint.

In some embodiments, the step of forming the weld joint includes forming a first weld pool along the abutting edges of the sheet metal pieces and allowing the weld pool to solidify, and the step of heating includes forming a second weld pool along the weld joint. The second weld pool is wider and/or shallower than the first weld pool.

In some embodiments, the step of forming the weld joint includes individual welding passes on respective opposite sides of the sheet metal pieces, and the step of heating includes a laser pass along a side of the weld joint having a greater penetration through a thickness of the sheet metal pieces.

In some embodiments, each sheet metal piece is formed from a same-gauge aluminum alloy.

In accordance with various embodiments, a method includes the steps of forming an initial weld joint and conditioning the initial weld joint. The initial weld joint is formed along abutting edges of two pieces of same gauge aluminum alloy sheet metal from material consisting essentially of material from each piece of sheet metal. The conditioning step is performed to change a grain structure of the initial weld joint such that a formability of the conditioned weld joint is greater than a formability of the initial weld joint.

In some embodiments, the initial weld joint includes a recess and the conditioning step includes heating the initial weld joint such that the recess is decreased in size without additional material being added.

In some embodiments, the conditioning step includes directing a defocused laser beam along the initial weld joint.

In some embodiments, the step of forming the initial weld joint includes directing a focused laser beam along the abutting edges of the sheet metal pieces without additional material being added. A laser spot of the defocused laser beam is larger than a laser spot of the focused laser beam.

In some embodiments, a grain structure of the initial weld joint includes grains with a direction of elongation, and the conditioning step includes changing the direction of elongation toward a thickness direction of the sheet metal pieces.

In some embodiments, the step of forming the initial weld joint includes forming a first weld pool along the abutting edges of the sheet metal pieces and allowing the weld pool to solidify, and the conditioning step includes forming a second weld pool along the initial weld joint. The second weld pool is shallower and/or wider than the first weld pool.

In some embodiments, the step of forming the initial weld joint includes individual welding passes on respective opposite sides of the sheet metal pieces, and the conditioning step includes a laser pass along a side of the weld joint having a greater penetration through a thickness of the sheet metal pieces.

In some embodiments, the step forming the initial weld joint includes laser welding using a first laser beam, the conditioning step includes using a second laser beam that follows the first laser beam along the sheet metals pieces.

In accordance with various embodiments, a sheet metal assembly includes a first sheet metal piece, a second sheet metal piece, and a weld joint. The second sheet metal piece has a same gauge as the first sheet metal piece. The weld joint joins the first and second sheet metal pieces together and is formed only from constituent metals of the first and second sheet metal pieces. The weld joint includes a first region, a second region, and a conditioned region. The first region extends at least partially through a thickness of the sheet metal assembly. The second region extends partially through the thickness of the sheet metal assembly and partially overlaps the first region. The conditioned region is defined where the first and second regions overlap. Grains of the weld joint are oriented differently in the conditioned region than in a portion of the first region outside the conditioned region.

In some embodiments, each sheet metal piece includes an O temper aluminum alloy.

In some embodiments, the first and second regions extend into the thickness of the sheet metal assembly from a same side of the sheet metal assembly. The first region has a depth greater than a depth of the second region, and the second region has a width greater than a width of the first region.

In some embodiments, the weld joint includes a third region extending partially through the thickness of the sheet metal assembly from an opposite side of the sheet metal assembly and overlapping the first region outside of the conditioned region.

In some embodiments, an average orientation of the grains within the conditioned region of the weld joint forms an angle of less than 45 degrees with the thickness direction of the sheet metal pieces.

### DRAWINGS

FIG. 1 is a perspective view of one step of an exemplary method of making a sheet metal assembly using a laser beam;

FIG. 2 is a cross-sectional view taken at the laser beam of FIG. 1;

FIG. 3 is a cross-sectional view taken along a weld joint formed in FIG. 1;

FIG. 4 is a perspective view of the sheet metal assembly of FIG. 1 during a subsequent step of conditioning the weld joint using a laser beam;

FIG. 5 is a cross-sectional view taken at the laser beam of FIG. 4;

FIG. 6 is a cross-sectional view taken along the conditioned weld joint formed in FIG. 4;

FIG. 7 is a cross-sectional view taken at a laser beam directed at an opposite side of the sheet metal assembly, which has been turned upside-down with respect to FIG. 4;

FIG. 8 is a cross-sectional view taken along the conditioned weld joint formed in

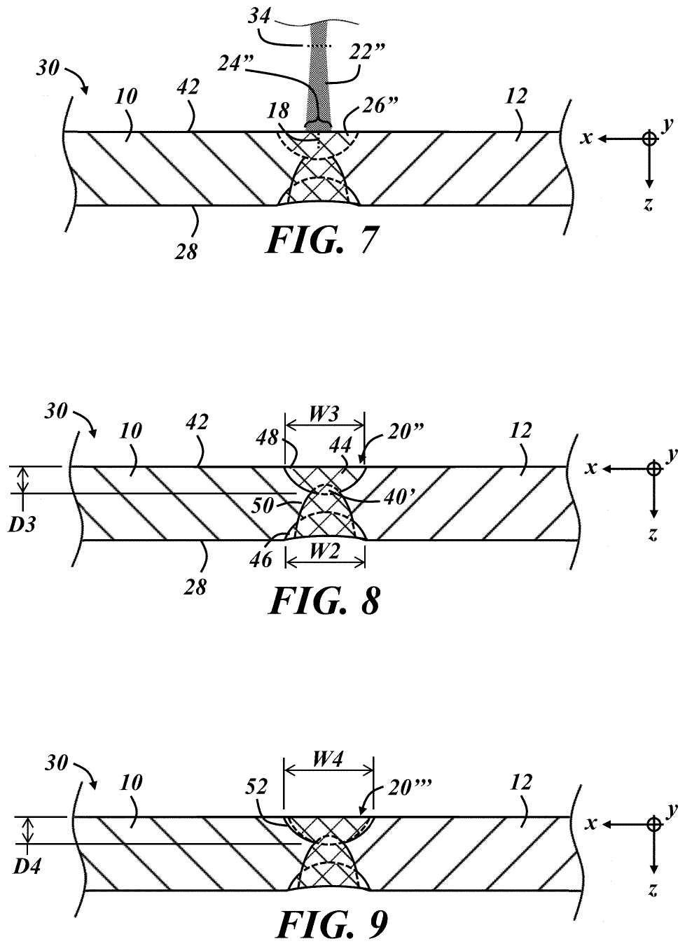

FIG. 7;

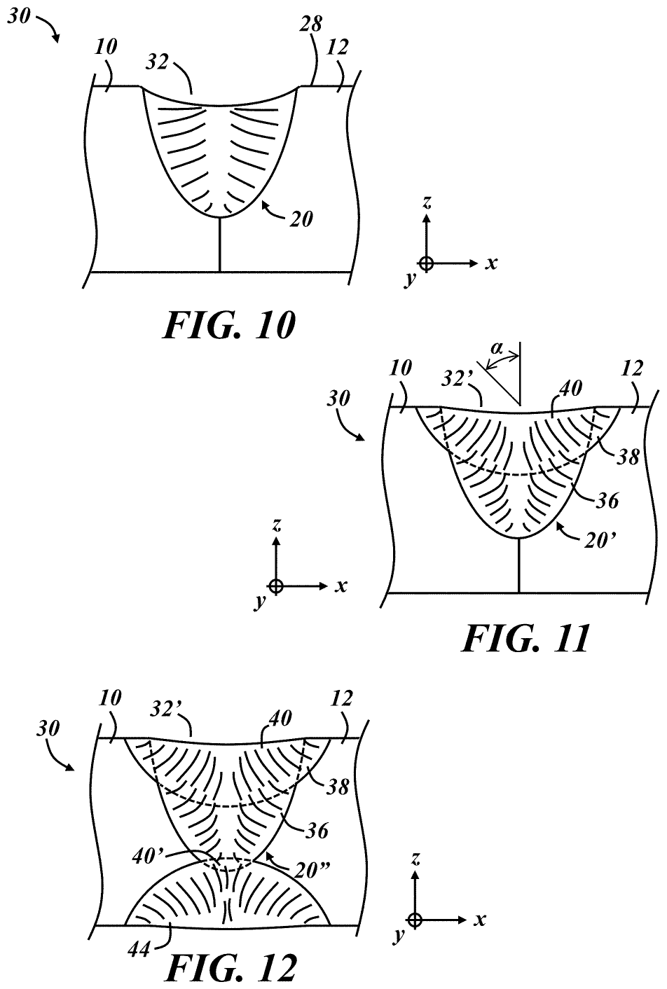

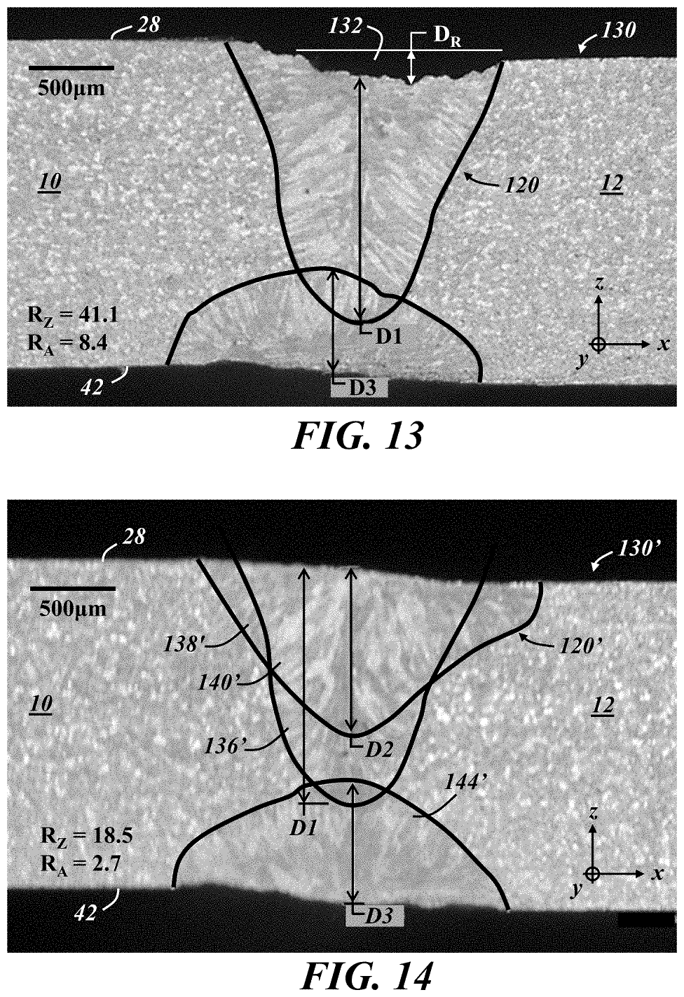

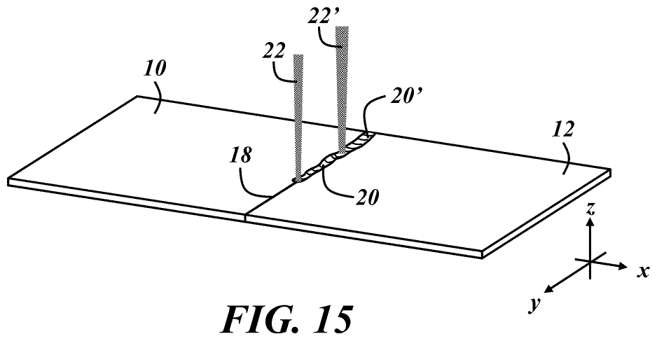

FIG. 9 is a cross-sectional view taken along the weld joint of FIG. 8 after an additional laser pass;

FIG. 10 is a schematic depiction of the grain structure of the weld joint of FIG. 3;

FIG. 11 is a schematic depiction of the grain structure of the conditioned weld joint of FIG. 6;

FIG. 12 is a schematic depiction of the grain structure of the weld joint of FIG. 8;

FIG. 13 is a photomicrograph of a weld joint of a sheet metal assembly formed with one laser pass on each opposite side of the assembly;

FIG. 14 is a photomicrograph of a weld joint of a sheet metal assembly formed with two laser passes on one side and one laser pass on the opposite side of the assembly; and

FIG. 15 is a perspective view of an exemplary method of making a sheet metal assembly using two laser beams on the same side of the assembly.

### DESCRIPTION

Described below is a sheet metal assembly and a method of making the sheet metal assembly. The method is useful with, but not limited to, same-gauge sheet metal welding where a butt weld is desired and/or where the sheet metal material has a relatively low viscosity when molten. The process can eliminate the need for filler material when welding materials, such as aluminum alloys, that normally require a filler material and can provide the resulting assembly with increased formability via advantageous manipulation of the geometry and/or grain structure of the weld joint.

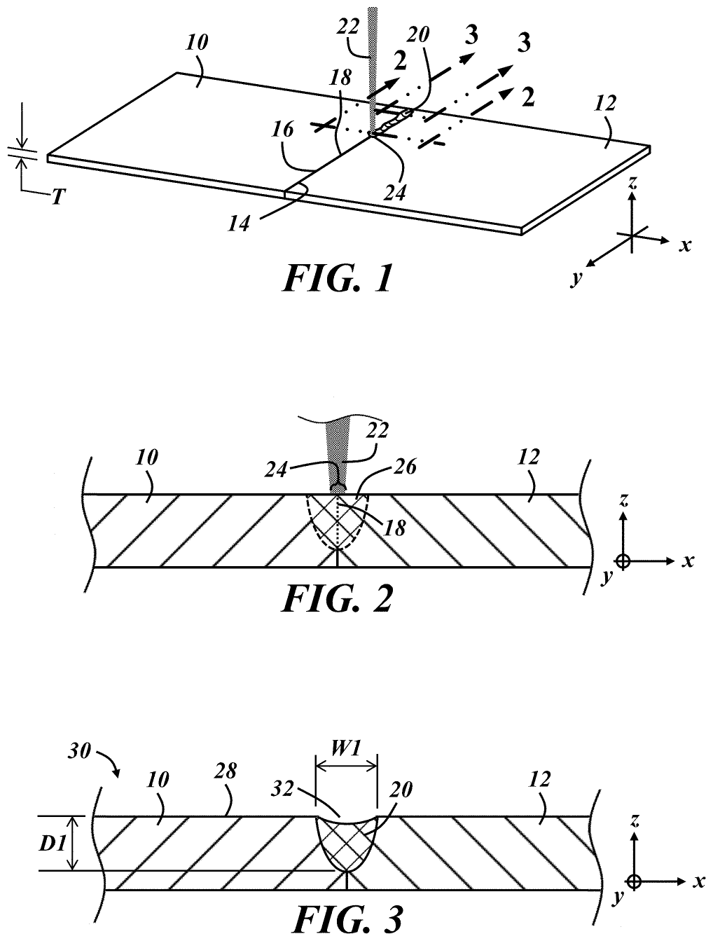

FIG. 1 is a perspective view of a step of an exemplary welding process in which a first sheet metal piece 10 and a second sheet metal piece 12 are welded together. An edge 14 of the first sheet metal piece 10 is abutted with an edge 16 of the second sheet metal piece 12 at an interface 18 along which the welding is performed. Each sheet metal piece 10, 12 has a thickness T measured in the z-direction of FIG. 1, which is the smallest dimension of each sheet metal piece. Opposite faces of each sheet metal piece 10, 12 extend in parallel x-y planes.

The illustrated method includes the step of forming a weld joint 20 along the abutting edges 14, 16 of the sheet metal pieces 10, 12. In this example, the weld joint 20 is formed by laser welding, which includes directing a laser beam 22 along the interface 18. The laser beam 22 moves with respect to the abutted sheet metal pieces 10, 12 such that a laser spot 24 is generally centered along the interface during the relative movement. In the illustrated example, movement of the laser spot 24 relative to the sheet metal pieces 10, 12 is in the y-direction.

As best illustrated in the cross-sectional view of FIG. 2, the laser beam 22 is configured to form a weld pool 26 of molten material from the edges 14, 16 of each sheet metal piece 10, 12. The laser beam 22 delivers laser light energy to the sheet metal pieces 10, 12 at the laser spot 24 at a wavelength at least partly absorbed by the sheet metal materials and with a power density sufficiently high to melt the sheet metal materials at the velocity at which the laser spot moves along the interface 18.

The weld pool 26 solidifies as the laser spot 24 continually moves along the interface 18 away from the molten material to form the weld joint 20 in a first laser pass. As used herein, a “laser pass” means a single exposure of the welding interface to the laser beam 22 between spaced apart points along the interface. If some portion of the interface is later exposed to the same or a different laser beam, that later exposure is considered to be part of a different laser pass.

The boundary of the weld pool 26 is depicted as a broken line in FIG. 2 and becomes the boundary of the weld joint 20, which is depicted as a solid line in FIG. 3. The interface 18 is effectively eliminated within the weld pool 26 in FIG. 2 as those portions of the sheet metal pieces 10, 12 become molten and are no longer distinguishable from one another in the weld pool or in the formed weld joint 20. The weld joint 20 has a depth D1 measured in the z-direction from a first or top side 28 of the sheet metal pieces, which is the side at which the laser beam is directed in FIGS. 1 and 2. The depth D1 may be referred to as a depth of penetration of the first weld pass into the sheet metal materials. The weld joint 20 also has a width W1 measured in the x-direction at its widest point, transverse to the direction of weld formation. The weld joint 20 holds the sheet metal pieces 10, 12 together as a welded sheet metal assembly 30.

The resulting weld joint 20 may have a recess 32 at the first side 28 of the assembly 30. For example, when the two sheet metal pieces 10, 12 have the substantially the same thickness T or are of the same gauge, the illustrated recess 32 may result due to a combination of gravity acting on the molten material during welding, an imperfect gap in the x-direction at the interface 18, imperfect z-direction alignment at the interface, a burr-down orientation of one or both edges 14, 16, low molten material viscosity, and/or other factors. As used herein, the gauge of each sheet metal piece is determined by industry standards for the particular type of sheet metal. A particular gauge of an aluminum alloy sheet metal may have a different thickness that the same nominal gauge of a steel alloy, for example. The sheet metal pieces are said to have substantially the same thickness if they are of the same material family and gauge or if they have respective thicknesses within 10% of each other.

The presence of the recess 32 may be undesirable, particularly where the sheet metal assembly 30 is intended for subsequent use in a metal forming operation in which the sheet metal assembly, including the weld joint 20, must undergo plastic deformation without breaking, such as in a forming operation for a vehicle body panel. The recess 32 represents an irregular geometry at the weld joint 20, which can act as a local stress riser and cause the weld joint 20 to break during the forming operation at strain levels that are not normally high enough to break the sheet metal material.

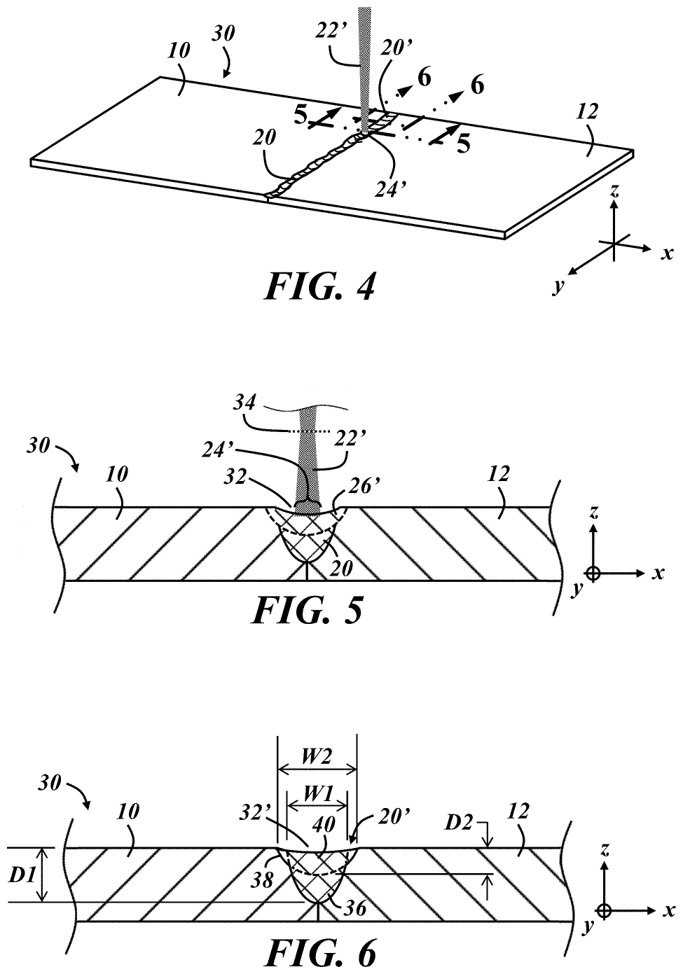

With reference to FIGS. 4-6, the method may further include the step of heating the weld joint 20 such that the recess 32 is decreased in size. The weld joint 20 may be considered an initial weld joint before the step of heating and a conditioned weld joint 20′ after the step of heating. In the illustrated example, the heating step is performed without additional material, such as conventional filler wire, being added to the weld joint either during or after formation of the initial weld joint 20.

In the illustrated example, the step of heating includes localized heating by directing a defocused laser beam 22′, or a laser beam of lower power density than the laser beam 22 that formed the initial weld joint 20, along the recess 32. The defocused laser beam 22′ has a focal plane 34 located outside the thickness of the sheet metal pieces 10, 12, as depicted in FIG. 5. In contrast, the initial weld joint 20 may be formed with a focused laser beam 22 having its focal plane within the thickness of the sheet metal pieces 10, 12. As such, one manner of providing the defocused laser beam 22′ includes using the same laser source used in formation of the initial weld joint 20 and increasing or decreasing the distance between the laser source and the sheet metal pieces 10, 12.

FIGS. 4 and 5 depict a second laser pass in which the defocused laser beam 22′ moves with respect to the sheet metal assembly 30 such that a laser spot 24′ follows the same path as the laser spot 24 of the first laser pass of FIG. 1 and is thus directed along the recess 32 of the initial weld joint 20. The defocused laser beam 22′ is configured to form a second weld pool 26′ of molten material, including material from the initial weld joint 20 and material from each of the sheet metal pieces 10, 12 just beyond the initial weld joint 20 in the widthwise or x-direction. The boundary of the second weld pool 26′ is depicted as a broken line in FIG. 5. The laser spot 24′ of the defocused laser beam 22′ is larger than the laser spot 24 of the focused laser beam 22 of FIGS. 1 and 2 and, therefore, has a lower power density at the same laser power. As shown in FIG. 5, this may also result in a shallower second weld pool 26′ relative to the first weld pool. In some embodiments, the laser beam 22′ is defocused to such a degree that the larger laser spot 24′ does not have sufficient power density to form a weld pool and the laser power is increased relative to the laser power used in initial weld joint formation.

This second weld pool 26′ solidifies to become part of the conditioned weld joint 20′, the boundary of which is illustrated as a solid line in FIG. 6. In the conditioned weld joint 20′, the recess 32′ is reduced in size relative to the initial weld joint 20 and may be referred to as a conditioned recess, if any recess at all remains. Stated differently, the recess 32 of the initial weld joint 20 is at least partially filled in as a result of the second laser pass, without the use of filler wire. This surprising result may be related to different surface tension effects in the second weld pool 26′ relative to the first weld pool, preferential shrinkage in different directions during solidification of the first and second weld pools due to their respectively different depths and widths, and/or a localized change in specific volume of some of the material of the weld joint, to cite a few possibilities.

The conditioned weld joint 20′ may be described as having a first region 36 defined by the initial weld joint 20 of FIG. 3, a second region 38 defined by the solidified second weld pool 26′ of FIG. 5, and a conditioned region 40 defined where the first and second regions overlap. The first region 36 has the depth D1 and width W1 of the initial weld joint 20 of FIG. 3. The second region 38 has a lesser depth D2 and a greater width W2 than the first region 36. The conditioned weld joint 20′ thus takes on the greater of the depths and widths of its combined regions 36, 38 with a depth D1 and a width W2. The conditioned region 40 of the conditioned weld joint 20′, within the broken line boundary of FIG. 6, takes on the lesser of the depths and widths of its combined regions 36, 38 with a depth D2 and a width W1.

FIG. 7 is a cross-sectional view of the sheet metal assembly 30 during a third laser pass along the interface 18 formed by the edges of the sheet metal pieces 10, 12. In this example, the sheet metal assembly 30 is inverted for the third laser pass in which a defocused laser 22″ is directed along the interface 18 at a second or bottom side 42 of the assembly, opposite the first side 28. The defocused laser beam 22″ and laser spot 24″ move with respect to the sheet metal assembly 30 generally following the same path as the first two laser passes, but on the opposite side of the assembly 30. The defocused laser beam 22″ forms a weld pool 26″ of molten material, including material from each of the sheet metal pieces 10, 12. In this example, no additional material is added to the weld pool during the third laser pass—which is also considered a first laser pass along the bottom side 42 of the sheet metal assembly 30. The laser spot 24″ of the defocused laser beam 22″ is larger than the laser spot 24 of the focused laser beam of FIGS. 1 and 2 and thus has a lower power density at the same laser power. The illustrated weld pool 26″ is shallower than the first weld pool 26 and may be similar to that of the second laser pass. In some embodiments, the laser parameters (e.g., power, power density at the laser spot, velocity of the laser spot along the interface, distance of focal plane from the sheet metal assembly, etc.) are the same in the second laser pass as in the third laser pass, but this is not necessary, as they could be different. The boundary of the weld pool 26″ is depicted as a broken line in FIG. 7 and becomes the boundary of a third region 44 of the conditioned weld joint 20″ as shown in FIG. 8.

The third laser pass eliminates the remaining unjoined portion of the interface 18 between the abutted edges of the sheet metal pieces 10, 12, and the conditioned weld joint 20″ now has a more complex shape, with its boundary depicted as a solid line in FIG. 8. The conditioned weld joint 20″ now has opposite first and second ends 46, 48 at opposite first and second sides 28, 42 of the assembly 30. The conditioned weld joint 20″ has a width W2 at the first end 46 and a width W3 at the second end 48. The widths W2 and W3 are each greater than a width of a central portion 50 of the conditioned weld joint 20″. The width W2 of the first end 46 is defined by that of the second region of the weld joint, and the width W3 of the second end 48 is defined by that of the third region 44 of the weld joint. The third region 44 has a depth D3 such that the third region partially overlaps the first region 36. Where this overlap occurs, a second conditioned region 40′ may be defined.

No recess is illustrated at the second end 48 of the weld joint 20′ in FIG. 8 because such a recess is less likely to occur given the conditions of the illustrated third pass. In particular, any gap between the edges of the sheet metal pieces is closed off by the weld joint formed in the first and second passes such that gravity cannot cause molten material to escape from the lower part of the joint. Additionally, the illustrated third laser pass has a lesser penetration than the first pass, and the weld pool thus has different shrinkage characteristics when solidifying. It should be understood, however, that these drawings are simply illustrations of examples of sheet metal assemblies and that other embodiments, such as ones where the second end 48 has a small recess or other non-planar configuration, are certainly possible.

FIG. 9 is a cross-sectional view of the weld joint 20′″ after an optional fourth laser pass, which may be performed in the same manner as the third laser pass except that the defocused laser beam may be defocused to a greater extent. Stated differently, the focal plane of the laser beam is moved further from the assembly 30 than in the third laser pass, thus making the laser spot larger than in the third laser pass and resulting in a wider weld pool. A fourth region 52 of the weld joint 20′″ is thus formed with a width W4 that is slightly larger than the width W3 of the third region 44. A depth D4 of the fourth region 52 may be slightly smaller than the depth D3 of the third region, as well. The differences in the dimensions of the third and fourth regions 44, 52 of the weld joint 20′″ are not as great as the dimensional differences of the first and second regions such that the effect on the geometry and other characteristics of the already existing weld joint is not as great for the fourth laser pass than for the second laser pass. But marginal improvement in formability of the sheet metal assembly may still be achieved for other reasons beyond weld joint geometry, as discussed further below.

FIGS. 10-12 are schematic depictions of the grain structure of the sheet metal assembly 30 at different stages of the above-described process. In particular, FIGS. 10-12 depict the grain structures of the weld joints of the respective cross-sectional views of FIGS. 3, 6 and 8. Each cross-section is enlarged in FIGS. 10-12 and cross-hatching is omitted for clarity.

FIG. 10 illustrates the sheet metal pieces 10, 12 joined by the initial weld joint 20, which includes the recess 32 as discussed above. Each line segment illustrated within the weld joint 20 schematically depicts an average grain orientation at the line segment. The orientation of each grain of metal is defined by its direction of elongation—i.e., its largest dimension in cross-section. The area outside the weld joint does not include any line segments, meaning that the grain structure there is generally uniform and, if the grains of metal have an elongated shape, their respective directions of elongation may be random.

In FIG. 10, the overall orientation of the grains of the grain structure within the initial weld joint 20 is closer to horizontal than to vertical—i.e., closer to parallel with an x-y plane than with the z-direction, or less than 45 degrees with respect to an x-y plane on average. Another way of describing the illustrated grain structure is that the grains extend in a direction generally perpendicular with the boundary of the weld joint 20 in the x- and/or y-direction. In this case, the grains deeper within the weld joint 20 in the z-direction are more vertically oriented than those near the top side of the assembly, following the curvature of the weld joint boundary.

FIG. 11 illustrates the effect of the second laser pass on weld joint grain structure.

The overall orientation of the grains of the grain structure within the second region 38 of the weld joint 20′ is closer to vertical than to horizontal—i.e., closer to parallel with the z-direction than to an x-y plane, or more than 45 degrees with respect to an x-y plane. Another way of describing the illustrated grain structure in the second region 38 of the conditioned weld joint 20′ is that, similar to the grains in the initial weld joint 20, the grains extend in a direction generally perpendicular with the boundary of the weld joint 20 in the x- and/or y-direction. But because the second region 38 is wider and shallower than the first region 36, the resulting average grain orientation is closer to the thickness direction (z) than the planar directions (x-y) of the sheet metal pieces.

As a result, the second laser pass may be said to have changed the grain structure of the initial weld joint 20 such that the average grain orientation in the conditioned region 40 of the weld joint 20′ is shifted toward the thickness direction (i.e., the z-direction) relative to the average grain orientation in the initial weld joint. This reorientation of the grain structure may also effect grains of metal in the first region 36 of the weld joint 20′ that are near but outside the boundary of the second region 38 of the weld joint.

The size of the recess 32 thus correlates to weld joint grain orientation with the size of the recess decreasing as an average angle α of orientation of the grains of the grain structure decreases. The angle α is measured with respect to the thickness direction of the sheet metal pieces.

FIG. 12 depicts the weld joint 20″ and its grain structure orientation after the above-described third laser pass. Some grain reorientation may also occur as a result of the third laser pass in the second conditioned region of the weld joint, albeit to a lesser extent since the grains deep within the first region 36 were at a smaller angle α to begin with.

FIGS. 13 and 14 are photomicrographs taken through weld joints of two different sheet metal assemblies formed by laser welding same-gauge aluminum alloy sheet metal pieces together. In these particular examples, the sheet metal pieces are formed from an O temper 5182 aluminum alloy at a thickness of 2.0 mm (i.e., 12-gauge). A fiber laser with a maximum power capability of 4500 Watts was used for all laser passes with the laser beam and laser spot moving along the sheet metal pieces at the same speed during each pass. No filler wire or filler material was used in any of the laser passes.

In the example of FIG. 13, a weld joint 120 was formed with one laser pass along the first (top) side 28 of the sheet metal pieces 10, 12 and one subsequent single laser pass along the second (bottom) side 42 of the sheet metal pieces. There was no second laser pass performed along either of the first or second sides 28, 42. The single top pass (STP) was performed with the laser beam at 2400 W and has a penetration depth (D1) of 1.48 mm, as measured at its deepest point with respect to the first side 28 of the resulting assembly 130. The single bottom pass (SBP) was performed with the laser beam at 4000 W with the focal plane shifted 5 mm away from the sheet metal pieces relative to the STP. The SBP has a penetration depth (D3) of 0.62 mm and overlaps the initial STP weld joint by about 0.3 to 0.4 mm. The resulting weld joint 120 has a recess 132 along the top side 28 of the assembly 30 with a depth (D_{R}) of about 0.25 mm in the specific plane of the cross-section. Profilometer readings taken across the weld joint (i.e., in the x-direction) on the top side 28 of the assembly 130 reveal a maximum z-variation (R_{Z}) of 41.1 μm and an average roughness (R_{A}) of 8.4 μm.

In the example of FIG. 14, the weld joint 120′ was formed with two laser passes along the first (top) side 28 of the sheet metal pieces 10, 12 and one subsequent single laser pass along the second (bottom) side 42 of the sheet metal pieces, consistent with the first, second, and third laser passes of the exemplary method illustrated in FIGS. 1-9. The first laser pass was performed along the first side 28 of the sheet metal pieces 10, 12 with laser parameters identical to those of the single top pass of FIG. 13 (i.e. same laser power and focal plane), and the third laser pass was performed along the second side 42 of the assembly 130′ with laser parameters identical to those of the single bottom pass of FIG. 13. But the conditioned weld joint 120′ of FIG. 14 was formed with a second laser pass performed along the first side 28 of the assembly 130′ and along the initial weld joint that was formed in the first pass. The laser parameters for the second laser pass were identical with those of the third laser pass except it was performed from the first side 28 of the assembly rather than the second side 42.

The first region 136′ of the conditioned weld joint 120′ has a depth (D1) of 1.47 mm and a width of about 1.5 mm, the second region 138′ has a depth (D2) of 1.02 mm and a width of about 2.1 mm, and the third region 144′ has a depth (D3) of 0.76 mm and a width of about 2.1 mm. Notably, there is no distinguishable recess in the conditioned weld joint 120′. While there is an apparent 0.1 mm to 0.2 mm dimensional variation in the z-direction across the joint 120′, this appears to be about equal to the z-offset between the two individual sheet metal pieces 10, 12 when abutted together for welding. Profilometer readings taken across the conditioned weld joint on the top side of the assembly 130′ reveal a maximum z-variation (R_{Z}) of 18.5 μm and an average roughness (R_{A}) of 2.7 μm. The average roughness (R_{A}) across the conditioned weld joint 120′ of FIG. 14 is thus only about 30-35% of that across the weld joint 120 of FIG. 13, which was formed with the second top pass omitted.

FIGS. 13 and 14 also illustrate the different grain orientation at the conditioned region 140′ of the weld joint 120′ of FIG. 14 relative to the corresponding region of the weld joint 120 of FIG. 13. In the weld joint 120 of FIG. 13, the grain orientation beneath the recess 132 and through a majority of the thickness of the weld joint is generally 45 degrees or less with respect to an x-y plane. In the weld joint 120′ of FIG. 14, the grain orientation from the first side 28 of the assembly and through a majority of the thickness of the weld joint is generally greater than 45 degrees with respect to an x-y plane. As discussed above in conjunction with FIGS. 10-12, grain orientation correlates to the size of the recess in the weld joint.

The formability of the weld joint 120′ of FIG. 14 is also greater than the formability of the weld joint of FIG. 13. Formability can be determined by a ball punch deformation test in which a standard-sized diameter ball is pressed against the sheet metal assembly along the weld joint in the z-direction with an underlying die supporting the surrounding portions of the sheet metal assembly. The sheet metal assemblies of FIGS. 13 and 14 were tested using a 22.2 mm ball according to the version of General Motors Worldwide standard number GMW16854 in effect as of May 2019. Other standardized ball punch deformation tests, such as Olsen-cup, Erichsen, ISO, or ASTM tests, may be used to evaluate formability.

The sheet metal assembly 130 of FIG. 13 broke along the weld joint 120 during ball punch deformation when tested to failure, indicating the weld joint is the weakest part of the assembly 130. In contrast, the sheet metal assembly 130′ of FIG. 14 broke along the joined sheet metal pieces 10, 12 and across the weld joint 120′ when tested to failure, indicating that the weld joint is at least as strong as the individual sheet metal pieces. The sheet metal assembly of FIG. 14 also failed at a higher deformation (10.8 to 10.9 mm) than that of FIG. 13 (8.6 to 9.5 mm).

The improved formability may be attributed in part to the reduction in the size or the elimination of the recess of the initial weld joint formed in the first laser pass. In other words, the geometry of the weld joint plays a role in that a larger recess results in a locally thin area of the welded assembly such that an applied load results in higher local stress at the recess. Reduction of the size of the recess therefore leads to better load distribution across the weld joint and into the sheet metal pieces.

Grain structure and orientation is also believed to play a role in the increased formability of the conditioned weld joint. As noted above, as the average angle of grain orientation is decreased with respect to the thickness direction, the size of the recess appears to decrease as well. But this decreased average angle of grain orientation may also itself contribute to better formability. Also, a weld joint having a variety of different grain orientations may be preferable to a weld joint in which one particular grain orientation dominates the grain structure. For instance, the second laser pass in the above-described process reorients the grains of metal in the conditioned region 140′ of the weld joint, but generally leaves the remainder of the first region 136′ unchanged. The resulting mixture of grain orientations may provide a more isotropic character to the weld joint.

Sheet metal assemblies have also been produced with a fourth laser pass along the second side of the assembly, consistent with FIG. 9. In one such example, the weld joint was formed with the first three laser passes identical to those used in the example of FIG. 14 and with the laser beam defocused by an additional 1 mm on the fourth pass. The resulting sheet metal assembly had a weld joint with a maximum variation (R_{Z}) across the joint of 15.3 μm and an average roughness (R_{A}) of 3.2 μm. When subjected to the same ball punch deformation test, the resulting assembly performed like that of the example of FIG. 14, breaking along the joined sheet metal pieces and across the weld joint rather than only at the weld joint.

FIG. 15 is a perspective view of another example welding process in which the first and second sheet metal pieces 10, 12 are welded together with two laser beams 22, 22′. In this example, the first and second laser passes, which respectively form the initial weld joint 20 and the conditioned weld joint 20′, are performed at the same time, or at least overlapping in time. The first laser beam 22 moves along the interface 18 to form a weld pool that solidifies into the initial weld joint 20, and the second defocused laser beam 22′ follows behind the first laser beam to form a wider and/or shallower weld pool that resolidifies into the conditioned weld joint 20′, in which a recess of the initial weld joint 20 may be reduced or eliminated and in which the grain structure may be altered from its original structure. The resulting sheet metal assembly may then be inverted for the third and fourth laser passes described above, as desired.

It should be noted that the above-described and illustrated examples are non-limiting. For instance, while the method and resulting assembly have proven advantageous with same-gauge aluminum alloy sheet metal welding, manipulation of the geometry and or grain structure of a weld joint may be useful with other types of materials, such as steel or magnesium alloys, whether or not the joined pieces are of comparable thicknesses and whether or not the initial weld joint was formed using laser welding or formed with or without filler wire. Also, while the above-described experimental results are disclosed in relation to 5182 aluminum alloy sheet material, the disclosed products and methods are applicable to other aluminum alloys, including but not limited to 5000 series, 6000 series, and 7000 series aluminum alloys. Other manners of heating the initial weld joint to condition it may be used as well, such as localized induction heating. A greater or lesser number of laser passes may be employed as well. For instance, the initial weld joint may be formed by non-laser means with 100% penetration into the sheet metal pieces and then conditioned with a laser beam such that only a single laser pass is required.

The dimensions of the weld joints described and illustrated herein are also non-limiting, but may have at least some of the following attributes. The depth D1 of the initial weld joint 20 may be in a range from 40-100% of the thickness T of the sheet metal pieces. The depth of the initial weld joint 20 is greater than 50% of the thickness T in some embodiments and greater than 60% or greater than 70% in other embodiments. The width W1 of the initial weld joint 20 may be less than or equal to its depth D1. The penetration of the second laser pass and the depth D2 of the second region 38 of the conditioned weld joint 20′ may be less than D1 and/or the width W2 of the second region of the conditioned weld joint may be greater than the width W1 of the initial weld joint. Also, the penetration of the third laser pass, when employed, and the depth D3 of the third region 44 of the conditioned weld joint 20″ may be less than D1 and/or the width W3 of the third region of the conditioned weld joint may be greater than W1. The sum of D1 and D3 may be greater than the thickness T of the sheet metal pieces such that the entire interface 18 in the z-direction is joined together. The depth D2 of the second region of the weld joint 20′ may be in a range from about 30% to about 80% of the depth D1 of the first region and/or in a range from about 20% to about 60% of the thickness T of the sheet metal pieces.

It is to be understood that the foregoing description is not a definition of the invention but is a description of one or more exemplary illustrations of the invention. The invention is not limited to the particular example(s) disclosed herein, but rather is defined solely by the claims below. Furthermore, the statements contained in the foregoing description relate to particular exemplary illustrations and are not to be construed as limitations on the scope of the invention or on the definition of terms used in the claims, except where a term or phrase is expressly defined above. Various other examples and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of forming a sheet metal assembly, comprising the steps of forming a weld joint along abutting edges of two sheet metal pieces and subsequently heating the weld joint such that a recess of the weld joint is decreased in size without additional material being added.

2. The method of claim 1, wherein the step of heating the weld joint includes directing a defocused laser beam along the recess.

3. The method of claim 2, wherein the step of forming the weld joint includes directing a focused laser beam along the abutting edges of the sheet metal pieces without additional material being added, a laser spot of the defocused laser beam being larger than a laser spot of the focused laser beam.

4. The method of claim 1, wherein the step of heating the weld joint includes changing an orientation of grains of a grain structure of the weld joint.

5. The method of claim 1, wherein the step of forming the weld joint includes forming a first weld pool along the abutting edges of the sheet metal pieces and allowing the weld pool to solidify, and the step of heating includes forming a second weld pool along the weld joint, the second weld pool being wider and/or shallower than the first weld pool.

6. The method of claim 1, wherein the step of forming the weld joint includes individual welding passes on respective opposite sides of the sheet metal pieces, and the step of heating includes a laser pass along a side of the weld joint having a greater penetration through a thickness of the sheet metal pieces.

7. The method of claim 1, wherein each sheet metal piece is formed from a same-gauge aluminum alloy.

8. A method of forming a sheet metal assembly comprising the steps of:
(a) forming an initial weld joint along abutting edges of two pieces of same gauge aluminum alloy sheet metal, wherein the initial weld joint is formed from material consisting essentially of material from each piece of sheet metal; and
(b) conditioning the initial weld joint to change the grain structure such that a formability of the conditioned weld joint is greater than a formability of the initial weld joint.

9. The method of claim 8, wherein the initial weld joint includes a recess and step (b) includes heating the initial weld joint such that the recess is decreased in size without additional material being added.

10. The method of claim 8, wherein step (b) includes directing a defocused laser beam along the initial weld joint.

11. The method of claim 10, wherein step (a) includes directing a focused laser beam along the abutting edges of the sheet metal pieces without additional material being added, a laser spot of the defocused laser beam being larger than a laser spot of the focused laser beam.

12. The method of claim 8, wherein a grain structure of the initial weld joint includes grains with a direction of elongation and step (b) includes changing the direction of elongation toward a thickness direction of the sheet metal pieces.

13. The method of claim 8, wherein step (a) includes forming a first weld pool along the abutting edges of the sheet metal pieces and allowing the weld pool to solidify, and step (b) includes forming a second weld pool along the initial weld joint, the second weld pool being shallower and/or wider than the first weld pool.

14. The method of claim 8, wherein step (a) includes individual welding passes on respective opposite sides of the sheet metal pieces, and step (b) includes a laser pass along a side of the weld joint having a greater penetration through a thickness of the sheet metal pieces.

15. The method of claim 8, wherein step (a) includes laser welding using a first laser beam and step (b) includes using a second laser beam that follows the first laser beam along the sheet metals pieces.

16. A sheet metal assembly, comprising:
a first sheet metal piece;
a second sheet metal piece having a same gauge as the first sheet metal piece;
a weld joint joining the first and second sheet metal pieces together, the weld joint being formed only from constituent metals of the first and second sheet metal pieces,
wherein the weld joint includes a first region extending at least partially through a thickness of the sheet metal assembly, a second region extending partially through the thickness of the sheet metal assembly and partially overlapping the first region, and a conditioned region defined where the first and second regions overlap, grains of the weld joint being oriented differently in the conditioned region than in a portion of the first region outside the conditioned region.

17. The sheet metal assembly of claim 16, wherein each sheet metal piece comprises an O temper aluminum alloy.

18. The sheet metal assembly of claim 16, wherein the first and second regions extend into the thickness of the sheet metal assembly from a same side of the sheet metal assembly, the first region has a depth greater than a depth of the second region, and the second region has a width greater than a width of the first region.

19. The sheet metal assembly of claim 18, wherein the weld joint includes a third region extending partially through the thickness of the sheet metal assembly from an opposite side of the sheet metal assembly and overlapping the first region outside of the conditioned region.

20. The sheet metal assembly of claim 16, wherein an average orientation of the grains within the conditioned region of the weld joint forms an angle of less than 45 degrees with the thickness direction of the sheet metal pieces.
